(19) United States
(12) Patent Application Publication
(10) Pub. No.: US 2009/0130273 A1
(43) Pub. Date: May 21, 2009

(54) FREEZE DRIED SUCRALOSE

(75) Inventors: Warren L. Nehmer, Decatur, IL (US); Christopher Robert King, Decatur, IL (US)

Correspondence Address: RATNERPRESTIA, P.O. BOX 1596, WILMINGTON, DE, 19899, US

(73) Assignee: TATE & LYLE TECHNOLOGY LIMITED, LONDON (GB)

(21) Appl. No.: 12/124,695

(22) Filed: May 21, 2008

Related U.S. Application Data
(60) Provisional application No. 60/931,319, filed on May 21, 2007.

(51) Int. Cl. A23L 1/236; A23P 1/10

(52) U.S. Cl. 426/385; 426/536

(57) ABSTRACT

A method of freeze drying sucralose includes contacting a sucralose solution with a cold surface or a cold fluid to freeze the solution, and evaporating the solvent to dry the sucralose. The sucralose solution may include undissolved crystalline sucralose. Non-agglomerated sucralose spheres may be produced in some aspects of the invention.

### CROSS REFERENCE TO RELATED APPLICATIONS

This patent application claims priority benefit of U.S. Provisional Patent Appln. No. 60/931,319, filed May 21, 2007, the entirety of which is incorporated herein by reference.

### BACKGROUND OF THE INVENTION

Sucralose (4,1′,6′-trichloro-4,1′,6′-trideoxygalactosucrose), a high intensity sweetener made from sucrose, can be used in many food and beverage applications.

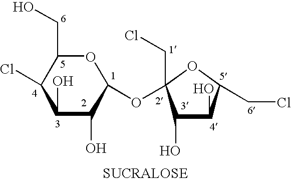

Unlike many artificial sweeteners, sucralose can be used in cooking and baking with no loss of sweetening power, and various forms of sucralose have been prepared to improve stability, ease handling, or otherwise adapt the use of sucralose to better suit any of a variety of end-use applications. Examples of such forms include needles, micronized (i.e., jet-milled), and agglomerated forms. Each of these has advantages and disadvantages, depending on the application.

Another alternative way of preparing particulate sucralose that might be considered would be to freeze dry it from a solution. However, as is known in the art, freeze drying of most organic compounds results in the formation of glassy (i.e., non-crystalline) product. For example, sucrose (common table sugar) is well known to behave in this way upon freeze drying. Not surprisingly, UK Patent Application GB 2,065,646 to Jenner and Waite notes that freeze drying sucralose likewise results in a glassy product, which the authors describe as difficult to handle because it is very hygroscopic, rapidly absorbing moisture from the air under humid conditions and thus “degenerating into a sticky mass.” Thus, although the use of freeze drying might otherwise be considered a possible alternative worth investigating, it appears not to have been considered a viable approach by those of skill in the art.

### SUMMARY OF THE INVENTION

In one aspect, the invention provides a method of producing sucralose beads. The method includes the steps of
a) forming droplets of a mixture including a solvent and dissolved sucralose;
b) contacting the droplets with a fluid medium at a temperature low enough to freeze the droplets; and
c) while maintaining the droplets in a frozen state, drying the frozen droplets to remove the solvent.

In another aspect, the invention provides a method of freeze drying sucralose. The method includes the steps of
a) depositing a mixture including a solvent and dissolved sucralose on a cold surface maintained at a temperature low enough to freeze the mixture; and
b) while maintaining the mixture in a frozen state, applying a vacuum to remove the solvent.

In yet another aspect, the invention also provides dried sucralose prepared by either of the above methods.

In a further aspect, the invention provides non-agglomerated solid spheres consisting of sucralose and optionally a buffer.

### BRIEF DESCRIPTION OF THE DRAWINGS

FIGS. 1, 2 and 3 are photomicrographs of exemplary sucralose beads according to the invention.

FIG. 4 is a plot of thermogravimetric data for a commercial sucralose sample.

FIG. 5 is a plot of thermogravimetric data for sucralose beads made from a seeded solution according to the invention.

FIG. 6 is a plot of thermogravimetric data for sucralose beads made from an unseeded solution according to the invention.

FIG. 7 is a differential scanning calorimetry plot for a commercial sucralose sample.

FIG. 8 is a differential scanning calorimetry plot for sucralose beads made from a seeded solution according to the invention.

FIG. 9 is a differential scanning calorimetry plot for sucralose beads made from an unseeded solution according to the invention.

### DETAILED DESCRIPTION OF THE INVENTION

The inventors have found that solutions of sucralose can be freeze dried to form crystalline sucralose, as opposed to the amorphous/glassy product described by Jenner and Waite.

The invention provides methods of producing crystalline sucralose by freeze drying. In one embodiment, the invention provides particles that are nearly perfectly spherical and that have an essentially smooth surface, as distinct from products produced by agglomeration, granulation or spray drying. The highly spherical shape provides dry, non-sticky particles having very good flow, very little dusting, and a pleasing appearance. In some embodiments, the degree of sphericity of the beads is such that each of at least 90% of them are essentially spherical, meaning that the shortest diameter of the bead is not less than 85% of the longest diameter. In most cases, the beads are even more nearly spherical than that, with at least 90% of them having a shortest diameter that is not less than 90% of the longest diameter.

Freeze drying of sucralose may be performed according to the invention by contacting droplets of a sucralose solution with a fluid medium at any temperature cold enough to freeze the droplets, and then drying (typically under vacuum) the still-frozen particles to evaporate the solvent. Typically, the temperature for the freezing step will be about −20° C. or less, more typically −50° C. or less, and most typically −100° C. or less. As used herein, reference to application of vacuum means exposure to reduced pressure. Typically, the pressure will be less than 800 millitorr absolute, more typically less than 100 millitorr absolute. A pressure of about 50 millitorr may be used in some embodiments.

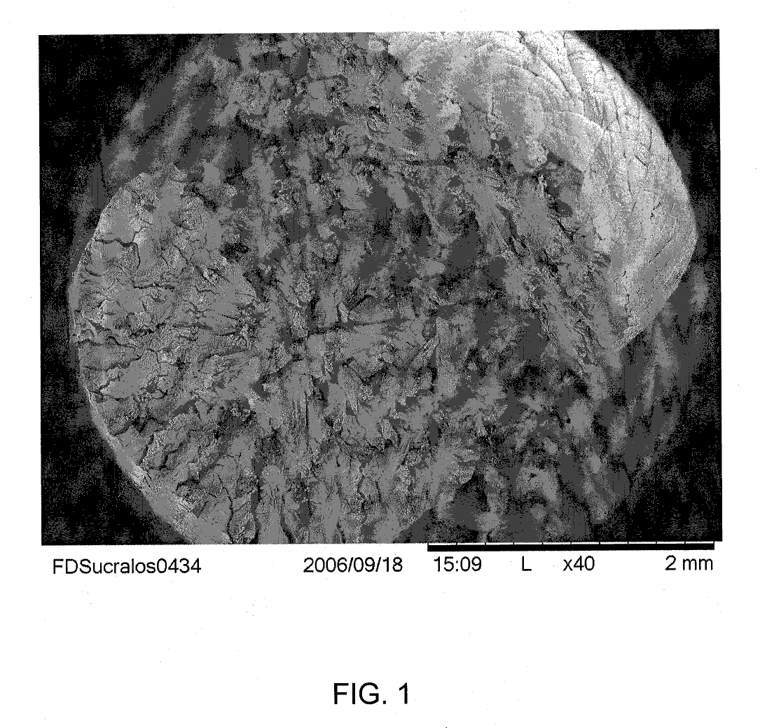

The solvent is typically water, but admixtures of water with other solvents may also be used. In most cases, a liquefied gas such as liquid nitrogen is used for the freezing step. However, other cryogenic liquids may be used instead, such as liquefied natural gas and liquefied refrigerant gases such as fluorocarbons, hydrofluorocarbons, chlorofluorocarbons, and the like. The particle size of the beads can be controlled over a wide range. Particles as large as about 5 mm diameter may be prepared by dispensing droplets of sucralose solution from a large enough dropper. For example, the diameter of the bead shown in FIG. 1 is about 4.5 mm. Beads as small as about 10 μm may be desired in some circumstances, and can be made by dispensing the solution from a sufficiently small orifice. More typically, beads in a range of 100 μm to 700 μm will be desired, and product in which at least 90 wt % are within this range can be achieved by suitable adjustments to the dispensing apparatus.

Freeze drying of the droplets may also be performed by spraying aqueous sucralose droplets into a gas carrier (typically air) at a temperature low enough to freeze the droplets (typically, less that about −50° C.) and allowing the suspended frozen droplets to dry. One example of such a method is disclosed in U.S. Pat. No. 7,363,726, “Powder Formation By Atmospheric Spray-Freeze Drying,” incorporated herein by reference, in which the drying is performed at or near atmospheric pressure. Optionally, a liquefied gas such as liquid nitrogen may be co-sprayed with the sucralose solution. In general, any method of contacting the droplets with any fluid medium (liquid or gas) that is cold enough to freeze them is suitable and is contemplated according to the invention, followed by volatilization of the solvent (optionally under vacuum) while still frozen to dry the beads.

Freeze drying according to the invention may also be performed by depositing a sucralose solution (for example, in sheet or droplet form) on a cold surface (such as a conveyor belt) maintained at a temperature cold enough to freeze the solution, and applying vacuum. Continuous freeze dryers for performing such an operation are available commercially from a number of manufacturers.

In any of the above methods, the sucralose solution that is to be freeze dried may be of any concentration. Typically, the solution will contain at least 20 wt % dissolved sucralose, more typically at least 30 wt %, and most typically at least 40 wt %. In some embodiments, a small amount of buffer may be added to the solution prior to freeze drying to enhance stability. If used, the buffer is typically present at a level of about 0.1 wt % relative to the total amount of sucralose in the mixture, and typically not more than about 2%. Suitable buffers include salts of weak acids. Typically, the salts will be alkali metal salts. The weak acids may include phosphoric acid, carbonic acid, and carboxylic acids. Exemplary carboxylic acids include formic, acetic, propionic, maleic, fumaric, and benzoic acid. Suitable specific compounds include sodium citrate or potassium citrate; sodium phosphate or potassium phosphate; amino acid bases such as arginine and lysine; sodium tartrate or potassium tartrate; sodium adipate or potassium adipate; sodium malate or potassium malate; sodium phosphate monobasic and sodium phosphate dibasic. Also suitable are sodium or potassium ascorbate, caprylate, gluconate, lactate, and sorbate.

In some embodiments, the sucralose solution contains essentially no undissolved sucralose, while in other embodiments the solution may be seeded with sucralose crystals, typically contributing no more than 10 wt % of the total sucralose in the mixture. More typically, the amount is no more than 5 wt %, and usually is no more than 2 wt %.

The freeze dried sucralose of this invention may be used in any of a variety of applications requiring the use of an artificial sweetener. For example, it may be dissolved in liquid products such as beverages or blended with solid ingredients such as other high intensity sweeteners, maltodextrin, sucrose, binders, and extenders.

### EXAMPLES

### Example 1

Freeze dried sucralose was prepared by dropping a sucralose solution into liquid nitrogen and then putting the frozen droplets into a vacuum freeze dryer to remove the moisture. A 50DS (50% dissolved solids) aqueous sucralose solution was prepared and then split into two batches. A small amount of ground sucralose crystals was added to one batch as seed, and the other was left unseeded. Approximately 5 mL of each batch was slowly dropped into a Dewar flask of liquid nitrogen from a small syringe. The drops froze almost instantly, forming small spherical sucralose “beads.” After all of the solution was dropped into the nitrogen, the excess liquid nitrogen was decanted off. The remaining nitrogen and the frozen sucralose beads were then poured onto a glass watch glass, which was immediately put into a vacuum freeze dryer at −50° C. After 24 hours in the dryer, the temperature was increased to approximately ambient while maintaining the vacuum. At that point, it was noted that the beads from the unseeded batch had a somewhat spongy or springy texture when pressed with a spatula, while the otherwise similar-looking beads from the seeded batch fractured when pressed hard. In some experiments, a slightly modified procedure was used in which the temperature started at −40° C. and was slowly ramped up to 25° C. over 24 hours, all under an absolute pressure of 50 millitorr.

X-ray diffraction analysis showed that both of the freeze dried samples of sucralose produced from aqueous solution had the same x-ray diffraction pattern as commercial crystalline sucralose in either needle or micronized form. This was surprising since it was expected that sucralose would, like most organic compounds, form only a glassy product by freeze drying. It was even more surprising in view of the specific confirmation by Jenner and Waite that sucralose indeed forms glassy product when freeze dried. Additionally, it was expected that the nearly instantaneous nature of freezing small droplets with liquid nitrogen would leave essentially no time for crystal formation, and therefore virtually assure the formation of glassy product. However, it is apparent that substantial crystallization of sucralose did indeed occur at some point during the preparation. In some embodiments, the sucralose in the beads is at least 55% crystalline. More typically, it is at least 850% crystalline, and usually at least 950% crystalline.

### Example 2

An effort was also made to freeze dry sucralose from solutions in alcohol. A 22% solution of sucralose in ethanol and a 50% solution of sucralose in methanol were each dropped into liquid nitrogen in the same manner as was used for the aqueous solutions. These samples took notably longer to freeze in the liquid nitrogen than the aqueous solutions. The frozen samples on the watch glass also melted within ten minutes of being put into the freeze dryer. Regardless, the melted syrup was left in the dryer for 24 hours. After this amount of time it was still wet and syrupy. These samples were then put into a room temperature vacuum chamber. After approximately two hours, these samples had dried and formed a thin flaky film. Efforts to produce stable beads from alcohol solvents were not successful.

Both products formed from aqueous solution were in the form of free flowing sucralose beads. SEM images of samples prepared from the unseeded sucralose solution are shown in FIGS. 1-3, performed using a Hitachi TM-1000 Tabletop Microscope. FIG. 1 shows an exemplary sucralose bead produced by freeze drying the unseeded aqueous sucralose solution described above. The spherical, smooth-surfaced bead has a diameter of about 4.5 mm and has been partially fractured, revealing a porous cracked interior having a high internal surface area. The interior has a large number of internal fissures that form voids within the solid sucralose that composes the particle. Each bead is formed from a single droplet of sucralose solution, and the solid sucralose within each bead is formed in place during the freeze drying. Thus, the beads consist of solid sucralose or sucralose fragments that form in situ, rather than a cluster of primary particles that have been formed separately and then agglomerated or otherwise bonded or adhered together to form the final beads. Thus, noncompound or non-agglomerated sucralose spheres can be prepared according to the invention.

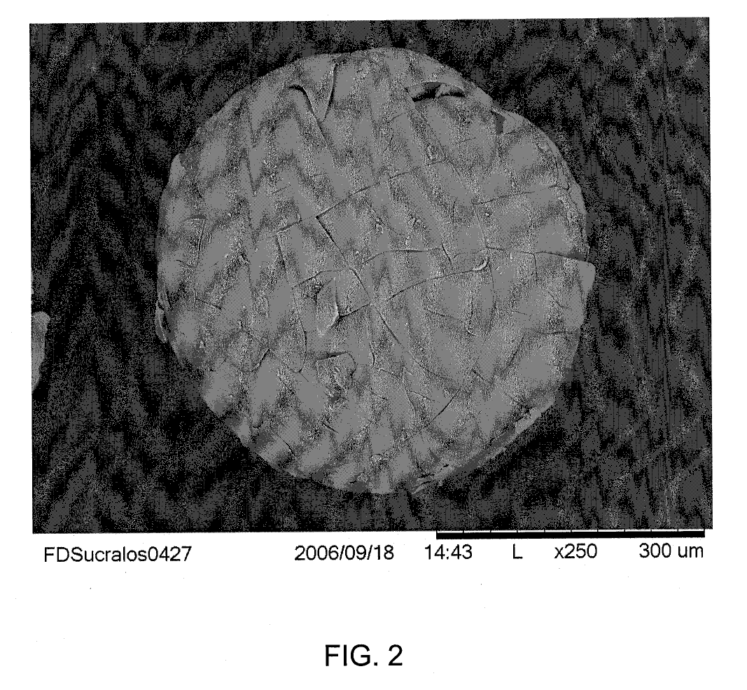

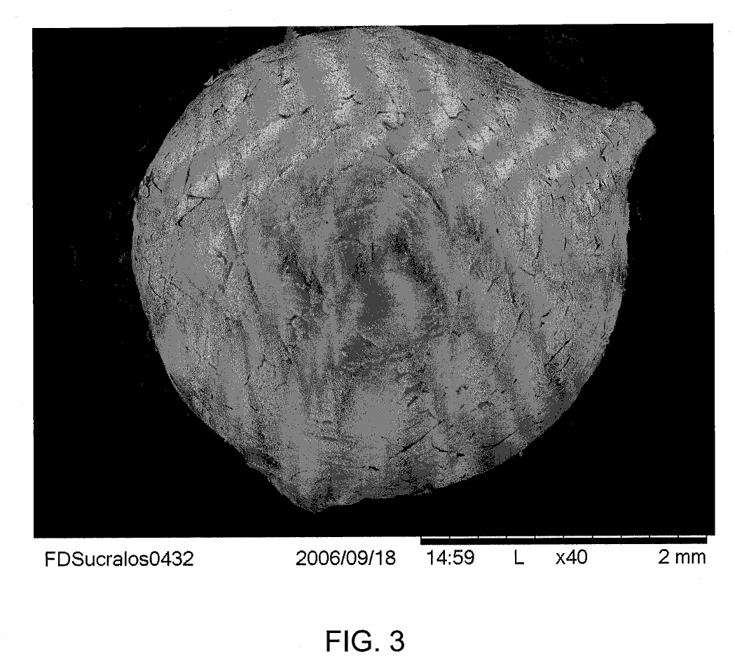

FIG. 2 shows another, smaller spherical bead having a diameter of about 0.5 mm. FIG. 3 shows a bead of about 3.2 mm diameter, essentially spherical but for the presence of a single necked region on the surface, believed to have resulted from freezing that occurred so quickly that the droplet did not have time to fully relax to a spherical shape before freezing. All of FIGS. 1, 2 and 3 show beads having an essentially spherical shape and a smooth surface marked with hairline fractures.

### Example 3

Sucralose beads prepared from seeded and unseeded aqueous sucralose solutions using the liquid nitrogen technique described above were evaluated to determine degree of moisture absorption as a function of relative humidity (% RH). A sample of commercial sucralose needles (“neat” sucralose) was also evaluated in parallel, and the results for these runs are shown in Table 1. Each column represents a ramping up of % RH from zero to 80, followed by ramping back down to 20.

TABLE 1
Mass Increase (%)

| % RH | Neat | Seeded | Not Seeded |
|---|---|---|---|
| 0 | 0.00 | 0 | 0.00 |
| 20 | 0.00 | 0.01 | 1.09 |
| 30 | 0.00 | 0.02 | 2.21 |
| 40 | 0.00 | 0.02 | 3.41 |
| 50 | 0.00 | 0.02 | 4.91 |
| 60 | 0.00 | 0.03 | 6.21 |
| 70 | 0.00 | 0.03 | 6.71 |
| 80 | 0.10 | 0.04 | 7.11 |
| 70 | 0.00 | 0.04 | 4.11 |
| 60 | 0.00 | 0.03 | 2.91 |
| 50 | 0.00 | 0.03 | 2.01 |
| 40 | 0.00 | 0.02 | 1.15 |
| 30 | 0.00 | 0.02 | 0.81 |
| 20 | 0.00 | 0.02 | 0.60 |

As can be seen, each of the three samples was significantly different from the others. The neat (commercial) product showed essentially zero moisture absorption until the RH reached 80%, at which the absorption jumped to 0.1%. In contrast, the seeded product began absorbing small amounts of moisture even at low RH, but the maximum value was less than half of that seen with the commercial product. In any case, the absorption was no greater than that of the commercial product under the same test conditions. The unseeded product was different from either of these. It showed significantly higher moisture absorption and further, unlike the other two, showed hysteresis in the moisture absorption/desorption behavior. That is, the mass increase values were significantly lower at most locations on the downward RH ramp than they were at the corresponding locations on the upward ramp, indicating that the product had changed in some way during the experiment. Thus, these products are all substantially different in their response to atmospheric moisture.

### Example 4

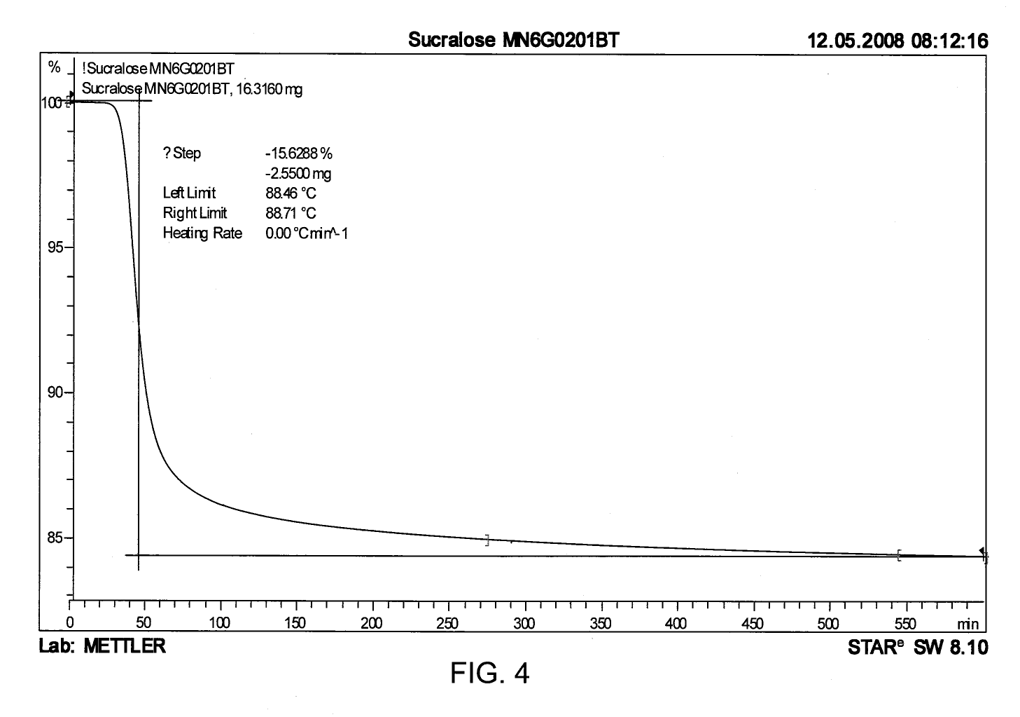

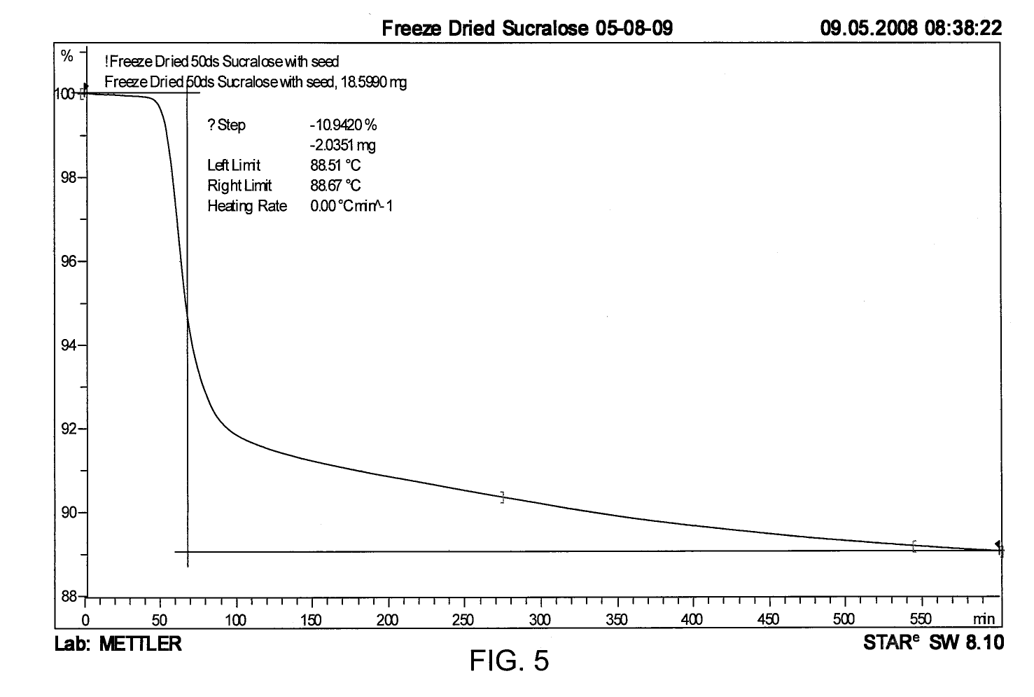

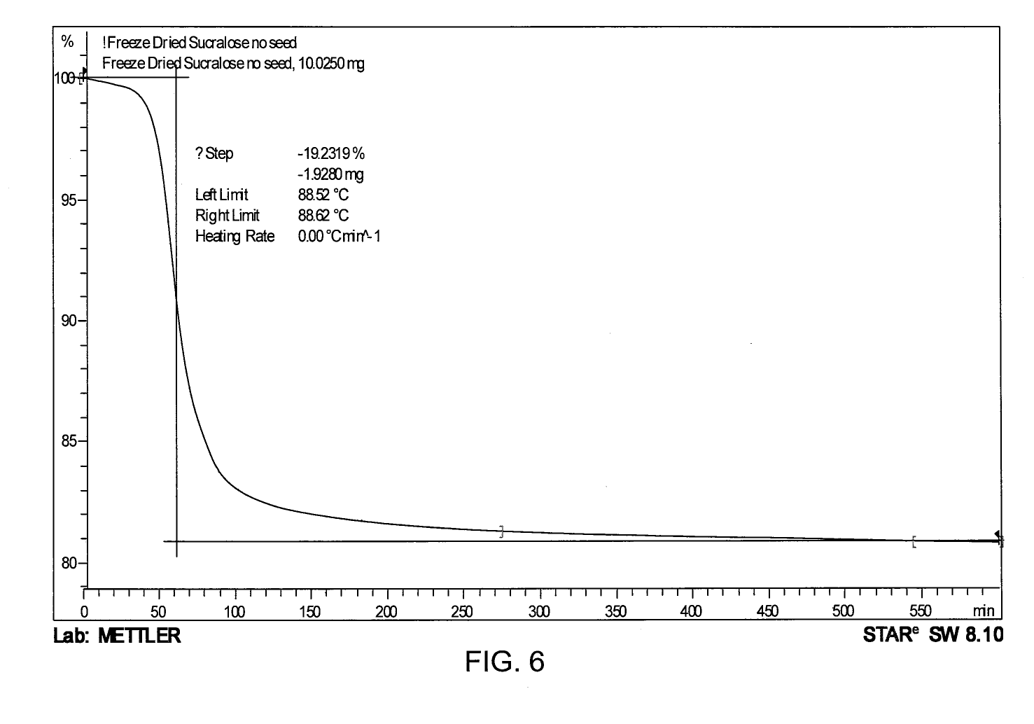

Thermogravimetric analysis was performed on commercial, seeded and unseeded samples made as described above in order to assess stability of the products at high temperature. The results are shown in FIGS. 4, 5 and 6, respectively. In each case, the mass of a sample was followed as a function of time at 90° C. in nitrogen, recorded as percent of original mass remaining. The vertical lines represent the point of the mass curve representing the halfway point of mass loss, and thus may be used as a measure of how rapidly decomposition set in. As can be seen by a comparison of the curves, the commercial sample was the earliest to show significant decomposition. The seeded product took considerably longer, and the unseeded product was intermediate between the two. This further bears out the fact, noted above in view of the moisture absorption results, that these samples represent three different forms of sucralose.

### Example 5

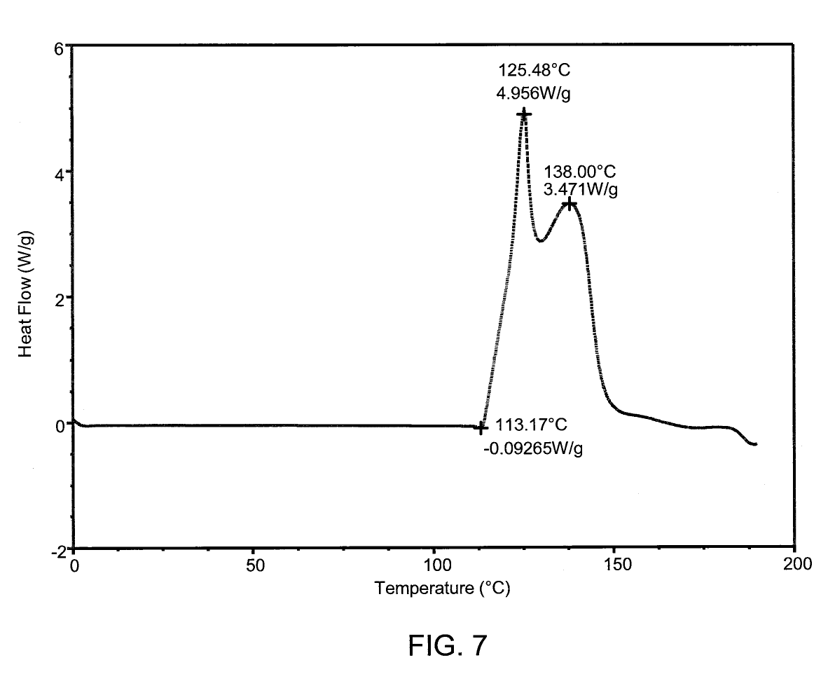

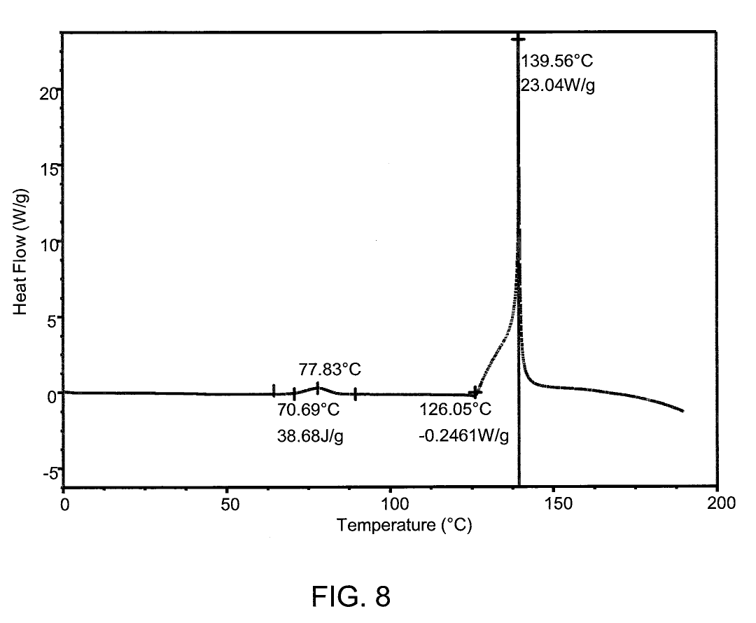

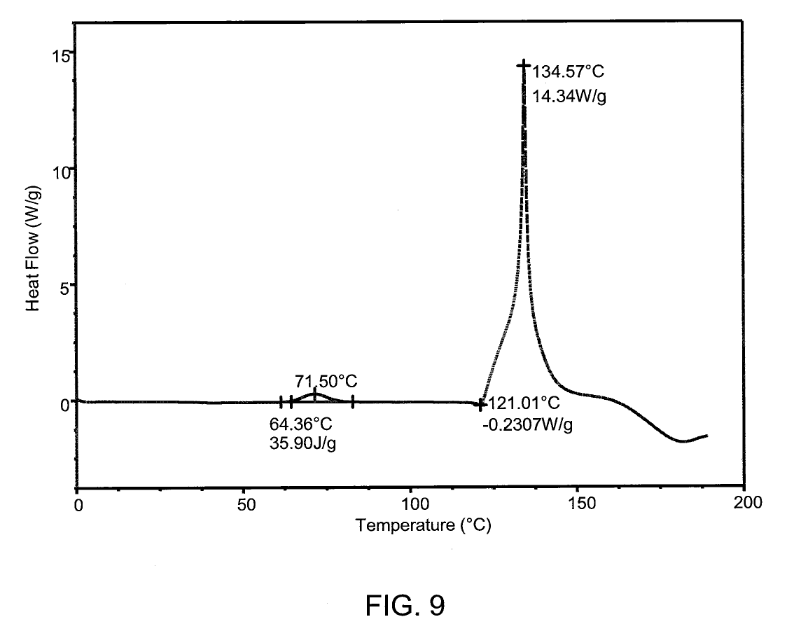

To further characterize the products of this invention, differential scanning calorimetry experiments were performed on commercial, seeded and unseeded samples made as described above. The resulting curves are shown in FIGS. 7, 8 and 9, respectively. Both the seeded and unseeded freeze dried sucralose beads show heat flow profiles that are strikingly different from that of commercial sucralose. Unlike the commercial sample, both freeze dried samples show an exotherm at lower temperatures: at about 72° C. for the unseeded sample and about 78° C. for the seeded sample. The unseeded sample begins its primary exotherm at a higher temperature (121° C.) than the commercial sample (113° C.), and the seeded sample begins even higher yet (125° C.). Most strikingly, the primary exotherms for the two freeze dried samples are sharp single spikes with a low temperature shoulder, while the commercial sample shows a very broad double peak. Thus, the thermograms of the three samples are distinct from each other in a way that again indicates different structure in the particles.

Although the invention is illustrated and described herein with reference to specific embodiments, the invention is not intended to be limited to the details shown. Rather, various modifications may be made in the details within the scope and range of equivalents of the claims without departing from the invention.

What is claimed:

1. A method of producing sucralose beads, comprising the steps of
a) forming droplets of a mixture comprising a solvent and dissolved sucralose;
b) contacting the droplets with a fluid medium at a temperature low enough to freeze the droplets; and
c) while maintaining the droplets in a frozen state, drying the frozen droplets to remove the solvent.

2. The method of claim 1, wherein the fluid medium is a liquefied gas.

3. The method of claim 1, wherein the fluid medium is liquid nitrogen.

4. The method of claim 1, wherein the step of drying comprises drying under vacuum.

5. The method of claim 1, wherein the solvent comprises water.

6. The method of claim 1, wherein the mixture further comprises undissolved crystalline sucralose.

7. The method of claim 1, wherein the mixture further comprises a buffer.

8. The method of claim 7, wherein the buffer is a salt of a carboxylic acid.

9. The method of claim 7, wherein the buffer is sodium acetate.

10. The method of claim 1, wherein each of at least 90% of the beads has a shortest diameter that is not less than 85% of its longest diameter.

11. The method of claim 1, wherein each of at least 90% of the beads has a shortest diameter that is not less than 90% of its longest diameter.

12. The method of claim 1, wherein at least 90 wt % of the beads have diameters in a range of 100 μm to 700 μm.

13. The method of claim 5, wherein the mixture further comprises undissolved crystalline sucralose.

14. The method of claim 5, wherein the step of drying comprises drying under vacuum.

15. The method of claim 5, wherein the fluid medium is liquefied gas.

16. The method of claim 5, wherein the fluid medium is liquid nitrogen.

17. The method of claim 13, wherein the step of drying comprises drying under vacuum and the fluid medium comprises liquid nitrogen.

18. Sucralose beads prepared by the method of claim 1.

19. Sucralose beads prepared by the method of claim 5.

20. Sucralose beads prepared by the method of claim 13.

21. A method of freeze drying sucralose, comprising the steps of
a) depositing a mixture comprising a solvent and dissolved sucralose on a cold surface maintained at a temperature low enough to freeze the mixture; and
b) while maintaining the mixture in a frozen state, applying a vacuum to remove the solvent.

22. The method of claim 21, wherein the mixture further comprises undissolved crystalline sucralose.

23. The method of claim 21, wherein the solvent is water.

24. Dried sucralose prepared by the method of claim 21.

25. Non-agglomerated solid spheres consisting of sucralose and optionally a buffer.

26. The spheres of claim 25, wherein the sucralose is at least 55% crystalline.

27. The spheres of claim 25, wherein the spheres absorb no more moisture at 80% relative humidity than commercial sucralose needles tested under the same conditions.

28. The spheres of claim 25, wherein the spheres absorb no more than 0.1 wt % of moisture at 80% relative humidity.
